(19) United States
(12) Patent Application Publication
(10) Pub. No.: US 2021/0070107 A1
(43) Pub. Date: Mar. 11, 2021

(54) PNEUMATIC TIRE

(71) Applicant: Toyo Tire Corporation, Itami-shi (JP)

(72) Inventor: Hiroshi Nashio, Itami-shi (JP)

(73) Assignee: Toyo Tire Corporation, Itami-shi (JP)

(21) Appl. No.: 16/922,345

(22) Filed: Jul. 7, 2020

(30) Foreign Application Priority Data
Sep. 10, 2019 (JP) 2019-164621

(51) Int. Cl. B60C 11/03; B60C 11/12

(52) U.S. Cl. CPC B60C 11/0306; B60C 2011/0358; B60C 2011/0341; B60C 11/12

(57) ABSTRACT

A pneumatic tire in an embodiment is provided with a shoulder land that is a land including a ground contact end. In the pneumatic tire, a circumferential groove which extends in a tire circumferential direction and both ends of which are closed is provided intermittently in the tire circumferential direction in the shoulder land. When a ground contact width of the shoulder land is set as A, the circumferential groove is provided within a range of A/2 on each side in a tire width direction from the ground contact end.

### CROSS-REFERENCE TO RELATED APPLICATION

The present application benefits by the priority right claimed in Japanese Patent Application No. 2019-164621 filed on Sep. 10, 2019 on the basis of Japanese Patent Application No. 2019-164621. Japanese Patent Application No. 2019-164621 is incorporated herein by reference in its entirety.

### TECHNICAL FIELD

The present invention relates to a pneumatic tire.

### BACKGROUND ART

For example, as disclosed in Patent documents 1 to 3, a pneumatic tire which is provided with: a main center groove near a tire equator; and a main shoulder groove near a ground contact end and in which a tread is divided into plural lands by these main grooves has been known. In addition, the pneumatic tire disclosed in each of Patent documents 1 to 3 is provided with plural grooves, each of which extends in a tire circumferential direction, at positions on the tire equator side in each of the lands.

By the way, in the case where a maximum cornering force of the pneumatic tire is excessively large, an excessive lateral force is generated on the pneumatic tire at the time when a driver turns a steering wheel significantly. FIG. 9 to FIG. 11 each illustrate a change in distribution of the lateral force with respect to a change in a slip angle. It is understood from these drawings that, as the slip angle is increased, the larger lateral force is generated in a portion near the ground contact end (that is, a portion on an outer side in a tire width direction) of each of the lands. Such an excessive lateral force impacts stability of a vehicle. In order to prevent generation of such an excessive lateral force, it is requested to reduce the maximum cornering force of the pneumatic tire to some extent.

However, in the case where the pneumatic tire is simply designed to reduce the cornering force thereof, cornering power is also reduced, which degrades responsiveness of the vehicle at the time when the driver slightly turns the steering wheel.
Patent Document 1: JP-A-2015-16839
Patent Document 2: JP-A-2015-30412
Patent Document 3: JP-A-2015-71373

### SUMMARY OF THE INVENTION

In view of the above, the present invention has a purpose of providing a pneumatic tire cornering power of which is high and a maximum cornering force of which is small.

A pneumatic tire in an aspect is provided with a shoulder land that is a land including a ground contact end. In the pneumatic tire, a circumferential groove which extends in a tire circumferential direction and both ends of which are closed is provided intermittently in the tire circumferential direction in the shoulder land. When a ground contact width of the shoulder land is set as A, the circumferential groove is provided in a range of A/2 on each side in a tire width direction from the ground contact end.

A pneumatic tire in an aspect is provided with an inter-main groove land that is a land held between two main grooves extending in a tire circumferential direction. In the pneumatic tire, a circumferential groove which extends in the tire circumferential direction and both ends of which are closed is provided intermittently in the tire circumferential direction in the inter-main groove land. The circumferential groove is provided in half a range on a ground contact end side in a width direction of the inter-main groove land.

A pneumatic tire in an aspect is provided with a center land that is a land including a tire equator. In the pneumatic tire, a circumferential groove which extends in a tire circumferential direction and both ends of which are closed is provided intermittently in the tire circumferential direction in the center land. The circumferential groove is provided in one-third of a range on a ground contact end side in a width direction of the center land.

Compared to the conventional pneumatic tire, a maximum cornering force of the pneumatic tire in the aspect is small while high cornering power thereof is maintained.

### BRIEF DESCRIPTION OF THE DRAWINGS

FIG. 1 illustrates a tread pattern of a pneumatic tire according to an embodiment.

FIG. 2 is a cross-sectional view taken along X-X in FIG. 1 in a depth direction.

FIG. 3 illustrates a tread pattern in a modified example in which circumferential grooves are only provided in shoulder lands.

FIG. 4 illustrates a tread pattern in another modified example in which the circumferential grooves are only provided in the shoulder lands and inter-main groove lands.

FIG. 5 illustrates a tread pattern in another modified example in which three main grooves are provided and the circumferential grooves are provided in the shoulder lands and the inter-main groove lands.

FIG. 6 illustrates a tread pattern in another modified example in which the three main grooves are provided and the circumferential grooves are only provided in the shoulder lands.

FIG. 7 illustrates a tread pattern in another modified example in which a length of two pitches of the shoulder land corresponds to a length of a single pitch of the inter-main groove land.

FIG. 8 illustrates a tread pattern in a comparative example.

FIG. 9 is a view illustrating distribution of a lateral force on a conventional pneumatic tire formed with the four main grooves at the time when a slip angle is 0° and in which a larger lateral force is exerted in a portion with a darker color.

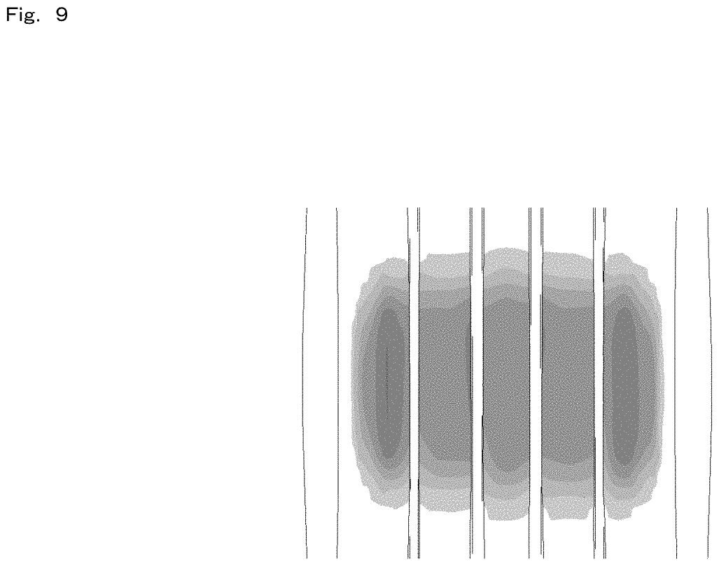

FIG. 10 is a view illustrating the distribution of the lateral force on the conventional pneumatic tire formed with the four main grooves at the time when the slip angle is 1° and in which the larger lateral force is exerted in the portion with the darker color.

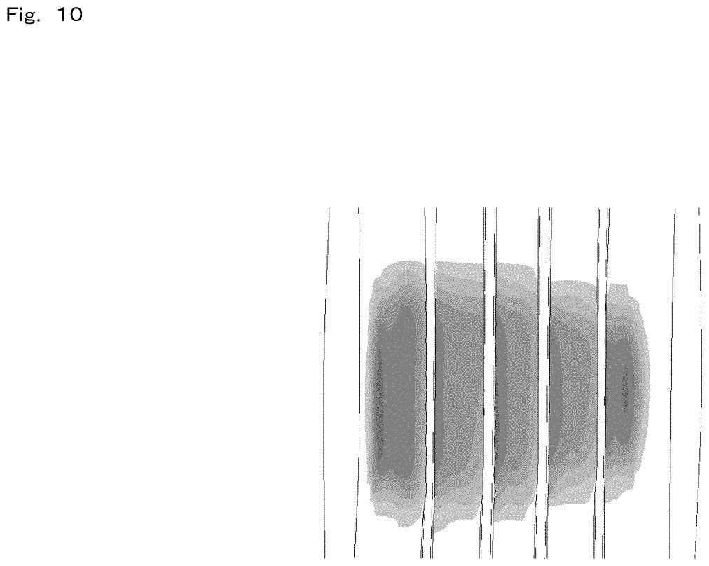

FIG. 11 is a view illustrating the distribution of the lateral force on the conventional pneumatic tire formed with the four main grooves with the slip angle at the time when a maximum cornering force is generated and in which the larger lateral force is generated in the portion with the darker color.

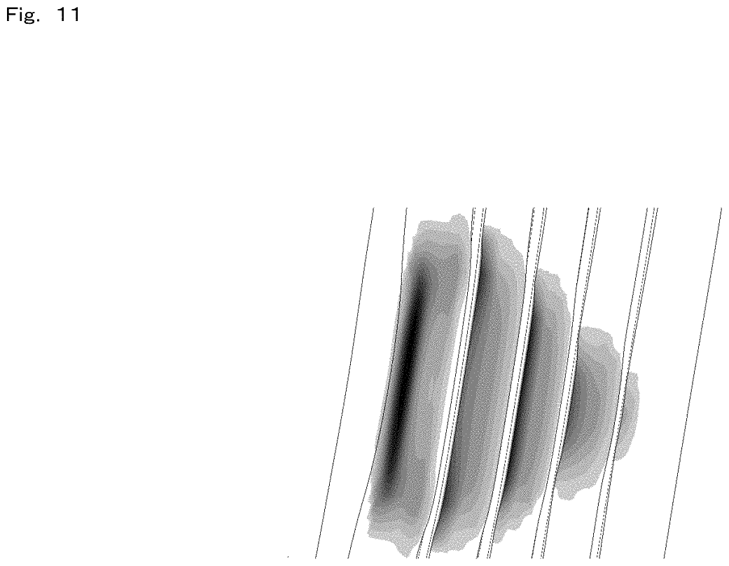

### EMBODIMENTS FOR CARRYING OUT THE INVENTION

### 1. Overall Structure of Pneumatic Tire

A pneumatic tire in an embodiment has a similar structure to a general radial tire except for a structure of a tread. The structure of the pneumatic tire in the embodiment will briefly be exemplified below.

First, a bead is provided on each side in a tire width direction. The bead includes: a bead core that is made of steel wire wound in a circular shape; and a bead filler that is made of rubber and provided on a radially outer side of the bead core. A carcass ply stretches between the beads on both of the sides in the tire width direction. The carcass ply is a sheet-shaped member in which a large number of ply cords aligned in an orthogonal direction to a tire circumferential direction are coated with the rubber. The carcass ply defines a framework shape of the pneumatic tire at a position between the beads on both of the sides in the tire width direction, and is folded from an inner side to an outer side in the tire width direction around each of the beads so as to wrap each of the beads. A sheet-shaped inner liner that is made of the rubber with low air permeability adheres to an inner side of the carcass ply.

One or plural belts are provided on an outer side of the carcass ply in a tire radial direction, and a belt reinforcing layer is provided on an outer side of the belt in the tire radial direction. The belt is a member that is formed by coating a large number of steel cords with the rubber. The belt reinforcing layer is a member that is formed by coating a large number of organic fiber cords with the rubber. The tread is provided on an outer side of the belt reinforcing layer in the tire radial direction. A sidewall is provided on each side in the tire width direction of the carcass ply. In addition to these members, members such as a belt under pad and chafers are provided according to the need for tire functions.

### 2. Tread Pattern

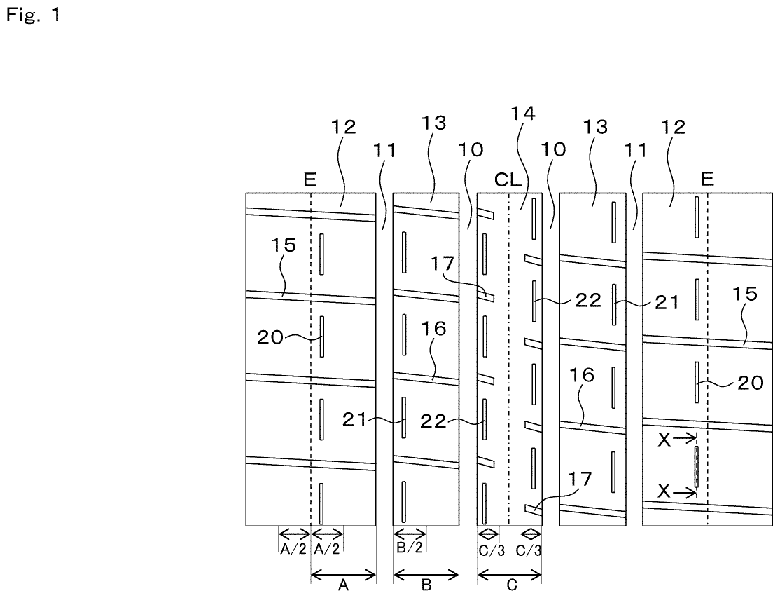

Next, a description will be made on a tread pattern formed in the tread. As illustrated in FIG. 1, the tread is provided with four main grooves, each of which extends in the tire circumferential direction. On each side of a tire equator CL (a center line in the tire width direction indicated by a one-dot chain line in FIG. 1), the main groove that is the closest to the tire equator CL is a main center groove 10. In addition, on each of the sides in the tire width direction, the main groove that is the closest to a ground contact end E (indicated by a broken line in FIG. 1) is a main shoulder groove 11.

The ground contact end E is an end portion in the tire width direction of a ground contact surface under a condition that the pneumatic tire attached to a legitimate rim and filled with air to have a legitimate inner pressure contacts the ground and a legitimate load is exerted thereon.

Here, the legitimate rim is specified as the “Standard Rim” in JATMA standards, the “Design Rim” in TRA standards, or the “Measuring Rim” in ETRTO standards. In addition, the legitimate inner pressure is specified as the “Maximum inflation pressure” in the JATMA standards, a maximum value set in the “TIRE LOAD LIMITS AT VARIOUS COLD INFLATION PRESSURES” in the TRA standards, or the “INFLATION PRESSURE” in the ETRTO standards. In the case where the pneumatic tire is used for a passenger vehicle, the legitimate inner pressure is 180 kPa. Furthermore, the legitimate load is specified as the “Maximum load capacity” in the JATMA standards, a maximum value set in the “TIRE LOAD LIMITS AT VARIOUS COLD INFLATION PRESSURES” in the TRA standards, or the “LOAD CAPACITY” in the ETRTO standards. In the case where the pneumatic tire is used for the passenger vehicle, the legitimate load is 85% of a corresponding load at the inner pressure of 180 kPa.

Five lands, each of which extends in the tire circumferential direction, are formed by these four main grooves 10, 11. More specifically, a shoulder land 12 is formed on an outer side in the tire width direction of the main shoulder groove 11, an inter-main groove land 13 is formed between the main center groove 10 and the main shoulder groove 11, and a center land 14 is formed between the two main center grooves 10. The inter-main groove land 13 in this embodiment is a so-called mediating land.

The shoulder land 12 is a land that includes the ground contact end E. That is, the ground contact end E exists in a range of the shoulder land 12. The center land 14 is a land that includes the tire equator CL. That is, the tire equator CL exists in a range of the center land 14.

The inter-main groove land 13 and the center land 14 have such a point in common that each of the inter-main groove land 13 and the center land 14 is interposed between the two main grooves. However, the inter-main groove land 13 and the center land 14 differ from each other in a point that, while the inter-main groove land 13 does not include the tire equator CL, the center land 14 includes the tire equator CL.

### 3. Structure of Shoulder Land

The shoulder land 12 is provided with a lateral groove 15 that extends in the tire width direction. The lateral groove 15 extends linearly in a direction that is slightly inclined with respect to the tire width direction. An end portion on the tire equator CL side of the lateral groove 15 is opened to the main shoulder groove 11, and an end portion on an opposite side from the tire equator CL of the lateral groove 15 is opened to the outer side in the tire width direction.

The plural lateral grooves 15 are provided at intervals in the tire circumferential direction. In this way, the shoulder land 12 is formed with a cyclic pattern in the tire circumferential direction. An interval between the two adjacent lateral grooves 15 in the tire circumferential direction corresponds to a pitch of the pattern.

The shoulder land 12 is also provided with a circumferential groove 20 that extends in the tire circumferential direction. Both end portions in an extending direction (that is, the tire circumferential direction) of the circumferential groove 20 are closed in the land. Such plural circumferential grooves 20 are provided intermittently in the tire circumferential direction.

The circumferential groove 20 is provided at a position near the ground contact end E or on the ground contact end E. More specifically, when a ground contact width of the shoulder land 12 is set as A, the circumferential groove 20 is provided in a range of A/2 on each of the sides in the tire width direction from the ground contact end E. In other words, the circumferential groove 20 is provided in a range from a position on the tire equator CL side by a distance of A/2 from the ground contact end E to a position on the outer side in the tire width direction by the distance of A/2 from the ground contact end E. The ground contact width is a width of the shoulder land 12 from the end portion on the main shoulder groove 11 side to the ground contact end E.

Here, a portion of the shoulder land 12 from the ground contact end E to the position on the outer side in the tire width direction by the distance of A/2 is a portion that does not contact the ground when not turning but contacts the ground during turning.

Such a circumferential groove 20 is provided at a rate of one or more (one in FIG. 1) per pitch of the pattern of the shoulder land 12. In a preferred embodiment, a total of a length in the tire circumferential direction of the circumferential groove 20 in the single pitch is equal to or longer than 40% and equal to or shorter than 90% of a length of the single pitch. For example, in the case where the single circumferential groove 20 is provided per pitch, the length in the tire circumferential direction of the single circumferential groove 20 is preferably equal to or longer than 40% and equal to or shorter than 90% of the length of the single pitch. Alternatively, in the case where the two circumferential grooves 20 are provided per pitch, the total of the lengths in the tire circumferential direction of the two circumferential grooves 20 is preferably equal to or longer than 40% and equal to or shorter than 90% of the length of the single pitch.

### 4. Structure of Inter-Main Groove Land

The inter-main groove land 13 is provided with a lateral groove 16 that extends in the tire width direction. The lateral groove 16 extends linearly in a direction that is slightly inclined with respect to the tire width direction. An end portion on the tire equator CL side of the lateral groove 16 is opened to the main center groove 10, and an end portion on the ground contact end E side of the lateral groove 16 is opened to the main shoulder groove 11.

The plural lateral grooves 16 are provided at intervals in the tire circumferential direction. In this way, the inter-main groove land 13 is formed with a cyclic pattern in the tire circumferential direction. An interval between the two adjacent lateral grooves 16 in the tire circumferential direction corresponds to a pitch of the pattern. A length of the pitch of the inter-main groove land 13 is the same as the length of the pitch of the shoulder land 12.

The inter-main groove land 13 is also provided with a circumferential groove 21 that extends in the tire circumferential direction. Both end portions in an extending direction (that is, the tire circumferential direction) of the circumferential groove 21 are closed in the land. Such plural circumferential grooves 21 are provided intermittently in the tire circumferential direction.

The circumferential groove 21 is provided in half a range on the ground contact end E side in the width direction of the inter-main groove land 13. In other words, when a length in the width direction of the inter-main groove land 13 is set as B, the circumferential groove 21 is provided in a range of a width B/2 on the ground contact end E side.

Such a circumferential groove 21 is provided at a rate of one or more (one in FIG. 1) per pitch of the pattern of the inter-main groove land 13. In a preferred embodiment, a total of a length in the tire circumferential direction of the circumferential groove 21 in the single pitch is equal to or longer than 40% and equal to or shorter than 90% of a length of the single pitch. For example, in the case where the single circumferential groove 21 is provided per pitch, the length in the tire circumferential direction of the single circumferential groove 21 is preferably equal to or longer than 40% and equal to or shorter than 90% of the length of the single pitch. Alternatively, in the case where the two circumferential grooves 21 are provided per pitch, the total of the lengths in the tire circumferential direction of the two circumferential grooves 21 is preferably equal to or longer than 40% and equal to or shorter than 90% of the length of the single pitch.

### 5. Structure of Center Land

The center land 14 is provided with a lateral groove 17 that extends in the tire width direction. The lateral groove 17 extends linearly in a direction that is slightly inclined with respect to the tire width direction. An end portion on the tire equator CL side of the lateral groove 17 is closed in the center land 14, and an end portion on the ground contact end E side of the lateral groove 17 is opened to the main center groove 10. Such a lateral groove 17 is also referred to as a notch. Such a lateral groove 17 is provided on each side in a width direction of the center land 14.

The plural lateral grooves 17 are provided at intervals in the tire circumferential direction. In this way, the center land 14 is formed with a cyclic pattern in the tire circumferential direction. An interval between the two adjacent lateral grooves 17 in the tire circumferential direction corresponds to a pitch of the pattern. A length of the pitch of the center land 14 is the same as the length of the pitch of the shoulder land 12 and that of the inter-main groove land 13.

The center land 14 is also provided with a circumferential groove 22 that extends in the tire circumferential direction. Both end portions in an extending direction (that is, the tire circumferential direction) of the circumferential groove 22 are closed in the land. Such plural circumferential grooves 22 are provided intermittently in the tire circumferential direction.

The circumferential groove 22 is provided in one-third of a range on the ground contact end E side in the width direction of the center land 14. In other words, when a length in the width direction of the center land 14 is set as C, the circumferential groove 22 is provided in a range in a width C/3 on one side in the width direction of the center land 14 and a range in a width C/3 on the other side in the width direction of the center land 14.

### 6. Structure of Circumferential Grooves

The width of each of the circumferential grooves 20, 21, 22 as described above is not limited. Each of the circumferential grooves 20, 21, 22 may be a sipe or a groove that is wider than the sipe. The sipe is a narrow groove. In detail, the sipe is a groove whose opening to the ground contact surface is closed under a condition that the pneumatic tire attached to the legitimate rim and filled with the air to have the legitimate inner pressure contacts the ground and that the legitimate load is exerted thereon.

The lengths or the widths of the circumferential grooves 20, 21, 22 are preferably great in a descending order of the shoulder land 12, the inter-main groove land 13, and the center land 14. Alternatively, both of the lengths and the widths of the circumferential grooves 20, 21, 22 may be great in the descending order of the shoulder land 12, the inter-main groove land 13, and the center land 14. Further alternatively, the lengths and the widths of the circumferential grooves 20, 21, 22 may be the same among all of the lands 12, 13, 14.

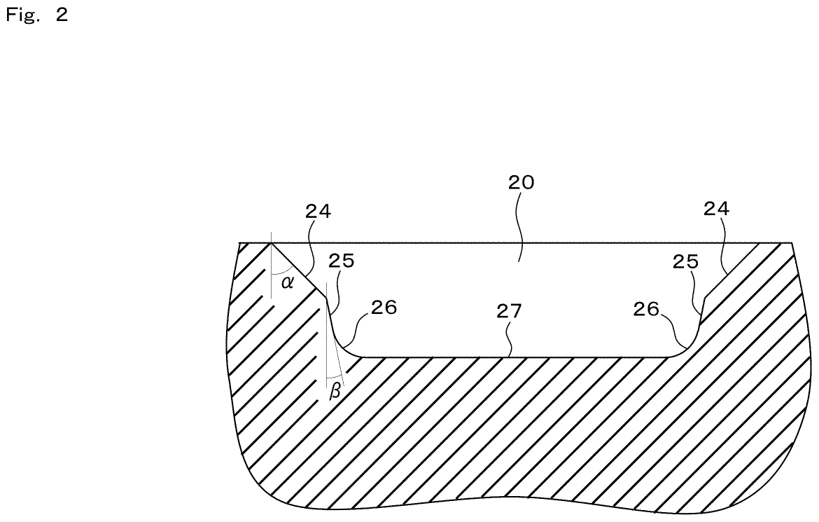

FIG. 2 illustrates a shape of the circumferential groove 20 of the shoulder land 12 in a depth direction. As described above, both of the end portions in the extending direction of the circumferential groove 20 are closed in the land, and both of the end portions thereof are inclined with respect to the depth direction of the circumferential groove 20. In detail, each of the end portions of the circumferential groove 20 is formed with: a first inclined section 24 that extends in the depth direction from the ground contact surface (a tire outer circumferential surface); and a second inclined section 25 that continues from the first inclined section 24 and further extends in the depth direction. The second inclined section 25 is further coupled to a groove bottom 27 via an R section 26.

The first inclined section 24 has a larger inclination angle with respect to the depth direction of the circumferential groove 20 (a perpendicular direction to the ground contact surface) than the second inclined section 25. That is, when the inclination angle of the first inclined section 24 with respect to the perpendicular direction to the ground contact surface is set as a, and the inclination angle of the second inclined section 25 with respect to the perpendicular direction to the ground contact surface is set as β, α>β is established. Specific numerical values of α and β preferably satisfy (1) and (2) below.

40°≤α≤70° (1)

β>tan⁻¹(tan α−0.7143) (2)

The circumferential groove 21 of the inter-main groove land 13 and the circumferential groove 22 of the center land also have the same cross-sectional shape as the circumferential groove 20 of the shoulder land 12.

Although not illustrated, a third inclined section that continues from the second inclined section 25 and further extends in the depth direction may be formed. Also in such a case, similar to the above, the inclination angle α of the first inclined section 24 is larger than the inclination angle β of the second inclined section 25. Meanwhile, an inclination angle of the third inclined section is not limited.

### 7. Operational Effects

As described above, in this embodiment, the circumferential groove 20, which extends in the tire circumferential direction and both of the end portions of which are closed, is provided intermittently in the tire circumferential direction in the shoulder land 12. In addition, when the ground contact width of the shoulder land 12 is set as A, the circumferential groove 20 is provided in the range of A/2 on each of the sides in the tire width direction from the ground contact end E.

Here, the range of A/2 on each of the sides in the tire width direction from the ground contact end E is a portion on which a large lateral force is likely to be generated at the time when a driver turns a steering wheel significantly. However, due to the provision of the circumferential groove 20, which extends in the tire circumferential direction (that is, a perpendicular direction to a direction of the lateral force), in the portion, the lateral force is reduced by the circumferential groove 20, and consequently, a maximum cornering force is reduced. In detail, with the circumferential groove 20, the rubber therearound moves in a manner to fall and degrades a ground contact property around the circumferential groove 20. As a result, a friction force is unlikely to be generated around the circumferential groove 20, and the lateral force is reduced. In this way, the maximum cornering force of the pneumatic tire is reduced.

In addition, the range of A/2 on each of the sides in the tire width direction from the ground contact end E is a range where a ground contact pressure is relatively small or which does not contact the ground at the time when the driver slightly turns the steering wheel. Accordingly, even with the provision of the circumferential groove 20, an influence thereof on the ground contact property is small, and an influence thereof on cornering power is extremely small.

From what has been described above, the pneumatic tire in this embodiment can exert the high cornering power while the maximum cornering force thereof is small.

Furthermore, in this embodiment, the circumferential groove 21 is provided in half the range on the ground contact end E side in the width direction of the inter-main groove land 13. The half of the range of the inter-main groove land 13 on the ground contact end E side in the width direction is a portion on which the large lateral force is likely to be generated at the time when the driver turns the steering wheel significantly. However, similar to the case of the shoulder land 12, due to the provision of the circumferential groove 21, the lateral force around the circumferential groove 21 is reduced, and consequently, the maximum cornering force of the pneumatic tire is reduced. In addition, when the driver slightly turns the steering wheel, the lateral force is small. Thus, an influence of the circumferential groove 21 on the cornering power is extremely small.

Moreover, in this embodiment, the circumferential groove 22 is also provided in one-third of the range on the ground contact end E side on each of the sides in the width direction of the center land 14. Similar to the cases of the shoulder land 12 and the inter-main groove land 13, due to the provision of the circumferential groove 22, the maximum cornering force of the pneumatic tire is reduced. However, an influence of the circumferential groove 22 on the cornering power is extremely small.

As described above, due to the provision of the circumferential grooves 21, 22 in the inter-main groove land 13 and the center land 14, respectively, the maximum cornering force is further reduced regardless of a fact that the cornering power is not reduced significantly.

Since one or more of each of such circumferential grooves 20, 21, 22 are provided per pitch of each of the lands 12, 13, 14, the circumferential grooves 20, 21, 22 exert an effect on the whole tire. In addition, since the total of the length in the tire circumferential direction of each of the circumferential grooves 20, 21, 22 in the single pitch is equal to or longer than 40% of the length of the single pitch, the effect of reducing the maximum cornering force is enhanced. Furthermore, since the total of the length in the tire circumferential direction of each of the circumferential grooves 20, 21, 22 in the single pitch is equal to or shorter than 90% of the length of the single pitch, the influence thereof on the cornering power can be suppressed.

As described above, the first inclined section 24, which extends in the depth direction of each of the circumferential grooves 20, 21, 22 from the ground contact surface, and the second inclined section 25, which continues from the first inclined section 24 and extends in the depth direction, are formed in both of the end portions of each of the circumferential grooves 20, 21, 22. The first inclined section 24 has the larger inclination angle with respect to the perpendicular direction to the ground contact surface than the second inclined section 25. That is, compared to the second inclined section 25, the first inclined section 24 extends in a near-parallel direction to the ground contact surface. Compared to the first inclined section 24, the second inclined section 25 extends in the depth direction of each of the circumferential grooves 20, 21, 22.

Since the first inclined section 24 extends in the near-parallel direction to the ground contact surface, the circumferential grooves 20, 21, 22 are each shallow near both of the end portions of the circumferential grooves 20, 21, 22, and strength of each of the end portions thereof is kept high. Since the strength of each of the end portions of the circumferential grooves 20, 21, 22 is high, each of the circumferential grooves 20, 21, 22 is less likely to be cracked from each of the end portions, and the cornering power is less likely to be reduced.

In addition, since the second inclined section 25 extends in the depth direction of each of the circumferential grooves 20, 21, 22, each of the circumferential grooves 20, 21, 22 becomes deep regardless of existence of the first inclined section 24, and a large deep area is secured for each of the circumferential grooves 20, 21, 22. Therefore, the effect of reducing the maximum cornering force is enhanced.

Here, in the case where the inclination angle α of the first inclined section 24 and the inclination angle β of the second inclined section 25 satisfy (1) and (2) described above, the maximum cornering force can be reduced appropriately while the appropriate cornering power is maintained.

Furthermore, the effect of the circumferential grooves 20, 21, 22 on the maximum cornering force of the pneumatic tire is increased as the circumferential grooves 20, 21, 22 are close to the ground contact end E. That is, such an effect is large in the descending order of the shoulder land 12, the inter-main groove land 13, and the center land 14. Therefore, in the case where the lengths or the widths of the circumferential grooves 20, 21, 22 are great in the descending order of the shoulder land 12, the inter-main groove land 13, and the center land 14, the maximum cornering force can be reduced effectively.

### 8. Modified Examples

The embodiment that has been described so far is merely illustrative, and the scope of the invention is not limited to the embodiment that has been described so far. Various modifications can be made to the embodiment that has been described so far within the scope that does not depart from the gist of the invention.

The following description will be made on plural modified examples. Any one of the plural modified examples may be applied to the above embodiment, or two or more of the plural modified examples may be combined and applied thereto.

(1) Modified Example of Arrangement of Circumferential Grooves

In the tread pattern provided with the shoulder land 12, the inter-main groove land 13, and the center land 14, any of the circumferential grooves 20, 21, 22 only needs to be provided in at least any one of the lands.

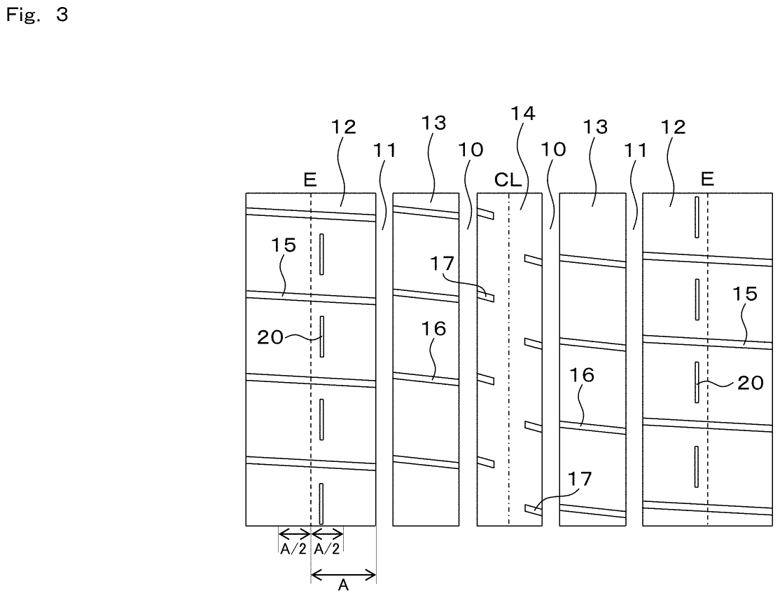

For example, as illustrated in FIG. 3, the circumferential grooves 20 may only be provided in the shoulder lands 12 on both of the sides in the tire width direction. Alternatively, the circumferential grooves 21 may only be provided in the inter-main groove lands 13 on both of the sides in the tire width direction. Further alternatively, the circumferential grooves 22 may only be provided in the center land 14.

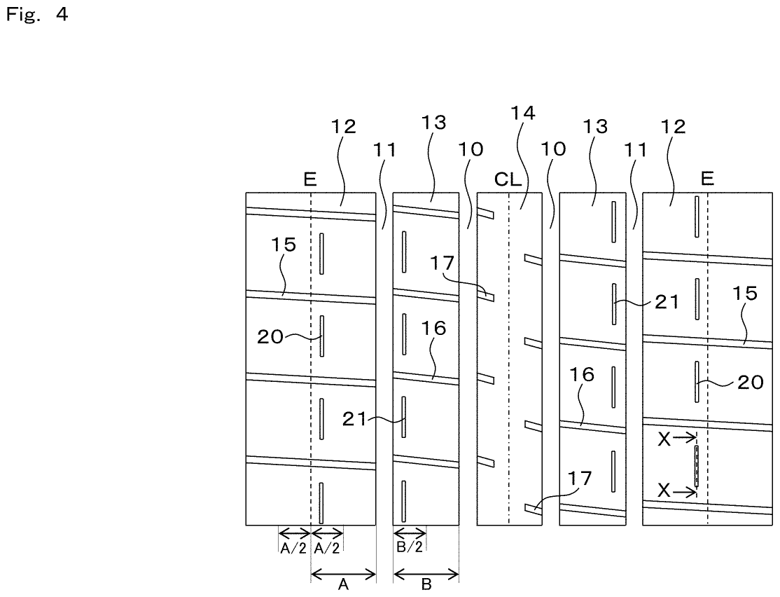

In addition, as illustrated in FIG. 4, the circumferential grooves 20, 21 may only be provided in the shoulder lands 12 and the inter-main groove lands 13, respectively.

Also, in any of these cases, due to the provision of at least one of the circumferential grooves 20, 21, 22, the maximum cornering force of the pneumatic tire is reduced. However, the influence of at least one of the circumferential grooves 20, 21, 22 on the cornering power is extremely small.

(2) Modified Example of Tread Pattern

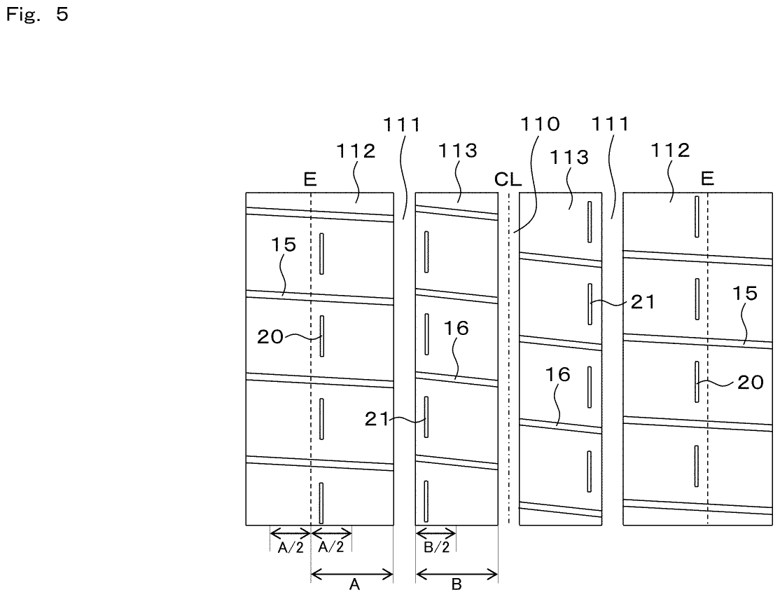

FIG. 5 illustrates a tread pattern in another modified example. In this tread pattern, three main grooves, each of which extends in the tire circumferential direction, are provided. More specifically, a main center groove 110 is provided to match the tire equator CL, and a main shoulder groove 111 that is the closest to the ground contact end E is provided on each side in the tire width direction.

Four lands, each of which extends in the tire circumferential direction, are formed by these three main grooves 110, 111. More specifically, a shoulder land 112 is formed on the outer side in the tire width direction of the main shoulder groove 111, and an inter-main groove land 113 is formed between the main center grooves 110 and the main shoulder groove 111. The shoulder land 112 is a land that includes the ground contact end E. Similar to the above embodiment, the shoulder land 112 and the inter-main groove land 113 are respectively provided with the lateral grooves 15, 16, and each of these lands 112, 113 is formed with a cyclic pattern in the tire circumferential direction.

In such a tread pattern, the shoulder land 112 is formed with the same circumferential groove 20 as that in the above embodiment, and the inter-main groove land 113 is also provided with the same circumferential groove 21 as that in the above embodiment.

One or more of each of these circumferential grooves 20, 21 are provided per pitch of each of the lands 112, 113. A total of a length of each of the circumferential grooves 20, 21 in the single pitch is preferably equal to or longer than 40% and equal to or shorter than 90% of a length in the tire circumferential direction of the single pitch. The lengths or the widths of the circumferential grooves 20, 21 are preferably greater in the shoulder land 112 than in the inter-main groove land 113.

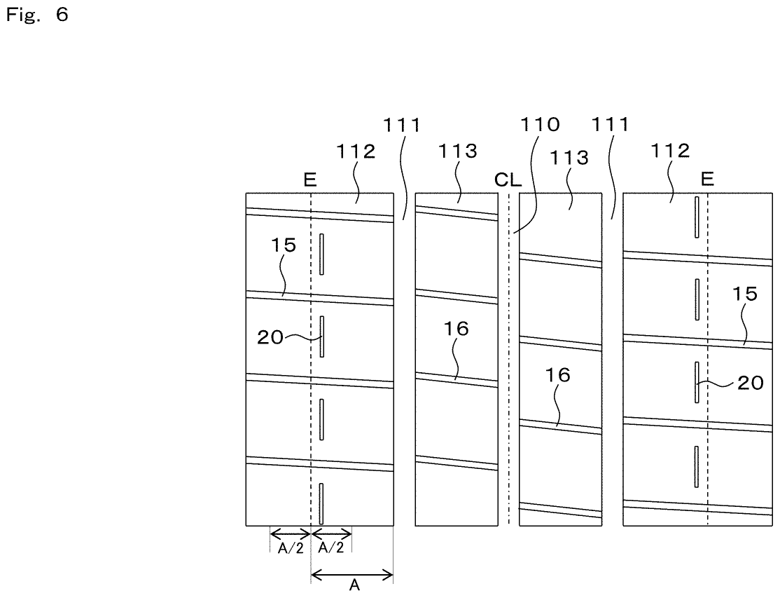

Here, the circumferential grooves 20, 21 may only be provided in the shoulder lands 112 or the inter-main groove lands 113. For example, as illustrated in FIG. 6, the circumferential grooves 20 may only be provided in the shoulder lands 112.

(3) Modified Example of Tread Pattern

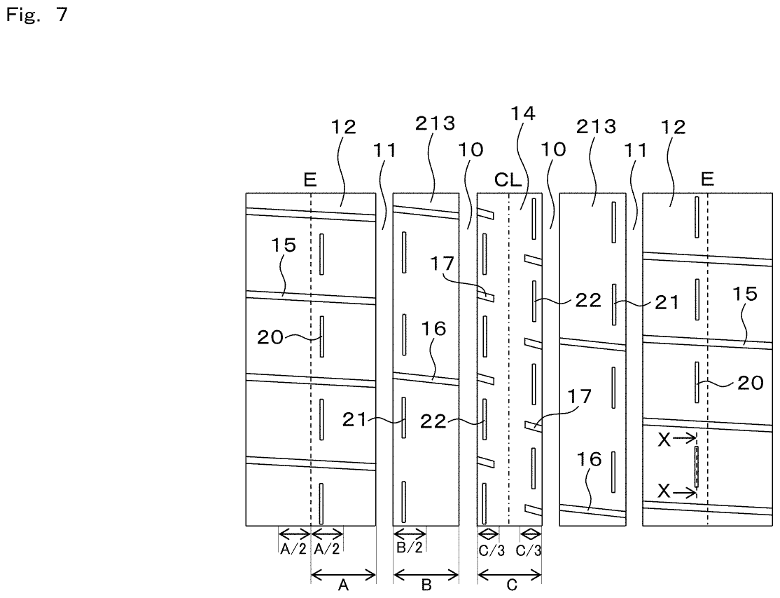

FIG. 7 illustrates a tread pattern in another modified example. In this modified example, the only one lateral groove 16 is provided in an inter-main groove land 213 for each two of the lateral grooves 15 in the shoulder land 12. Accordingly, a length of the two pitches of the shoulder land 12 corresponds to a length of a single pitch of the inter-main groove land 213.

In the inter-main groove land 213 in this modified example, the two circumferential grooves 21 are provided in the single pitch (that is, between the lateral groove 16 and the lateral groove 16). In this case, a total of lengths in the tire circumferential direction of the two circumferential grooves 21 is preferably equal to or longer than 40% and equal to or shorter than 90% of the length of the single pitch.

As in this modified example, the length of the single pitch of the land may differ by the land. Alternatively, two or more of the circumferential grooves may be provided per pitch of the land. In this case, the total of the lengths in the tire circumferential direction of the circumferential grooves in the single pitch is preferably equal to or longer than 40% and equal to or shorter than 90% of the length of the single pitch.

(4) Modified Example of Lateral Groove

The lateral grooves that are provided in the shoulder land 12 and the inter-main groove land 13 are slightly inclined with respect to the tire width direction in FIG. 1 and the like but may extend without being inclined with respect to the tire width direction. Alternatively, at least one end portion of the lateral groove may be closed in the land.

In addition, the lateral groove may be the sipe. The sipe is the narrow groove. In detail, the sipe is the groove whose opening to the ground contact surface is closed under the condition that the pneumatic tire attached to the legitimate rim and filled with the air to have the legitimate inner pressure contacts the ground and that the legitimate load is exerted thereon.

### 9. Example and Comparative Example

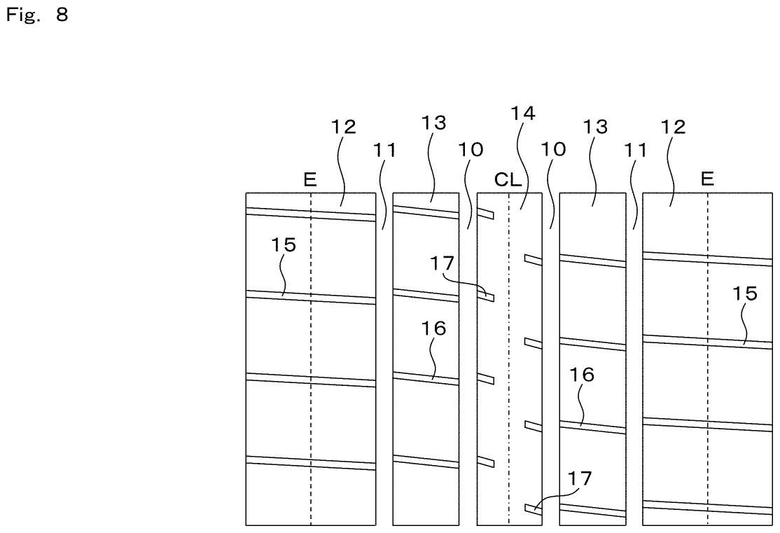

Cornering power and a maximum cornering force of a pneumatic tire in each of an example and a comparative example were measured. As the pneumatic tire in the example, the pneumatic tire with the tread pattern in FIG. 1 was used. As the pneumatic tire in the comparative example, the pneumatic tire with the tread pattern in FIG. 8 was used. In FIG. 8, the same portions as those in the tread pattern illustrated in FIG. 1 are denoted by the same reference signs. The two tread patterns differ in a point that the circumferential grooves 20, 21, 22 are provided in the tread pattern illustrated in FIG. 1 while no circumferential groove is provided in the tread pattern illustrated in FIG. 8.

Measurement results are shown in Table 1. In Table 1, measurement values in the example are expressed as indices at the time when measurement values in the comparative example are set to 100. It is indicated that the cornering power or the maximum cornering force is greater as the index is increased. As it is understood from Table 1, the maximum cornering force in the example was smaller than that in the comparative example. In addition, the cornering power in the example was slightly lower than that in the comparative example. However, a change amount thereof falls within an allowable range.

TABLE 1

| | Comparative | |
|---|---|---|
| | example | Example |
| Tread pattern | FIG. 8 | FIG. 1 |
| Cornering power | 100 | 99 |
| Maximum cornering | 100 | 95 |
| force | | |

1. A pneumatic tire provided with a shoulder land that is a land including a ground contact end, wherein
a circumferential groove which extends in a tire circumferential direction and both ends of which are closed is provided intermittently in the tire circumferential direction in the shoulder land, and
when a ground contact width of the shoulder land is set as A, the circumferential groove is provided in a range of A/2 on each side in a tire width direction from the ground contact end.

2. A pneumatic tire provided with an inter-main groove land that is a land between two main grooves extending in a tire circumferential direction, wherein
a circumferential groove which extends in the tire circumferential direction and both ends of which are closed is provided intermittently in the tire circumferential direction in the inter-main groove land, and
the circumferential groove is provided in half a range on a ground contact end side in a width direction of the inter-main groove land.

3. A pneumatic tire provided with a center land that is a land including a tire equator, wherein
a circumferential groove which extends in a tire circumferential direction and both ends of which are closed is provided intermittently in the tire circumferential direction in the center land, and
the circumferential groove is provided in one-third of a range on a ground contact end side in a width direction of the center land.

4. The pneumatic tire according to claim 1, wherein
an inter-main groove land that is a land between two main grooves extending in the tire circumferential direction is provided adjacent to the shoulder land, and
a circumferential groove is provided intermittently in the tire circumferential direction in half a range on a ground contact end side of the inter-main groove land.

5. The pneumatic tire according to claim 4, wherein
a center land that is a land including a tire equator is provided adjacent to the inter-main groove land, and
a circumferential groove is provided intermittently in the tire circumferential direction in one-third of a range on a ground contact end side of the center land.

6. The pneumatic tire according to claim 1, wherein
one or more of the circumferential grooves are provided per pitch of the land, and
a total of a length in the tire circumferential direction of the circumferential groove in a single pitch is equal to or longer than 40% and equal to or shorter than 90% of a length of the single pitch.

7. The pneumatic tire according to claim 2, wherein
one or more of the circumferential grooves are provided per pitch of the land, and
a total of a length in the tire circumferential direction of the circumferential groove in a single pitch is equal to or longer than 40% and equal to or shorter than 90% of a length of the single pitch.

8. The pneumatic tire according to claim 3, wherein
one or more of the circumferential grooves are provided per pitch of the land, and
a total of a length in the tire circumferential direction of the circumferential groove in a single pitch is equal to or longer than 40% and equal to or shorter than 90% of a length of the single pitch.

9. The pneumatic tire according to claim 1, wherein
a lateral groove that extends in the tire width direction is provided in the land provided with the circumferential groove.

10. The pneumatic tire according to claim 2, wherein
a lateral groove that extends in the tire width direction is provided in the land provided with the circumferential groove.

11. The pneumatic tire according to claim 3, wherein
a lateral groove that extends in the tire width direction is provided in the land provided with the circumferential groove.

12. The pneumatic tire according to claim 1, wherein
a first inclined section, which extends in a depth direction of the circumferential groove from a ground contact surface, and a second inclined section, which continues from the first inclined section and further extends in the depth direction, are formed in both closed end portions of the circumferential groove, and the first inclined section has a larger inclination angle with respect to a perpendicular direction to the ground contact surface than the second inclined section.

13. The pneumatic tire according to claim 2, wherein
a first inclined section, which extends in a depth direction of the circumferential groove from a ground contact surface, and a second inclined section, which continues from the first inclined section and further extends in the depth direction, are formed in both closed end portions of the circumferential groove, and the first inclined section has a larger inclination angle with respect to a perpendicular direction to the ground contact surface than the second inclined section.

14. The pneumatic tire according to claim 3, wherein
a first inclined section, which extends in a depth direction of the circumferential groove from a ground contact surface, and a second inclined section, which continues from the first inclined section and further extends in the depth direction, are formed in both closed end portions of the circumferential groove, and the first inclined section has a larger inclination angle with respect to a perpendicular direction to the ground contact surface than the second inclined section.

15. The pneumatic tire according to claim 4, wherein
a length or a width of the circumferential groove is greater in the shoulder land than in the inter-main groove land.

16. The pneumatic tire according to claim 5, wherein
a length or a width of the circumferential groove is great in a descending order of the shoulder land, the inter-main groove land, and the center land.
